(19) United States
(12) Patent Application Publication
(10) Pub. No.: US 2018/0266833 A1
(43) Pub. Date: Sep. 20, 2018

(54) AUTONOMOUS DRIVING AVAILABILITY MAP

(71) Applicants: Justin W Carlson, Commerce Township, MI (US); Philip Mallinger, Shelby Township, MI (US)

(72) Inventors: Justin W Carlson, Commerce Township, MI (US); Philip Mallinger, Shelby Township, MI (US)

(21) Appl. No.: 15/459,643

(22) Filed: Mar. 15, 2017

(51) Int. Cl. G01C 21/34; G01C 21/36; G05D 1/00

(52) U.S. Cl. CPC G01C 21/3407; G05D 1/0088; G01C 21/3667

(57) ABSTRACT

A map of a road network is displayed on a display of a system of an automotive vehicle with a an autonomous driving level indicator for each road in the road network that has autonomous driving available that indicates the level of autonomous driving that the road has available.

The present invention relates to a method of displaying a map of a road network on a display of an automotive vehicle with the roads in the road network marked to their levels of autonomous driving availability.

### BACKGROUND

Many automotive vehicles have systems, such as navigation systems, that display a map of a road network on a display of the system. The map displayed is typically of a local road network that can be expanded or contracted so that the map that is displayed is of a smaller geographic area with more detail or larger geographic areas with less detail. There are presently six levels of autonomous driving (including Level 0 which is full driver control/no autonomous driving functionality), as originally defined by the Society of Automotive Engineers in its J3016 specification and also now set forth in the National Highway Traffic and Safety Administration in the Department of Transportation's Federal Automotive Vehicles Policy (September, 2016). These levels range from full driver control (no automatic vehicle control) to full automated driving. More specifically, these levels as set forth in the Department of Transportation's Federal Automotive Vehicles Policy are:
Level 0 Automated system has no vehicle control, but may issue warnings;
Level 1 Driver must be ready to take control at any time. Automated system may include features such as Adaptive Cruise Control (ACC), Parking Assistance with automated steering, and Lane Keeping Assistance (LKA) Type II in any combination;
Level 2 The driver is obliged to detect objects and events and respond if the automated system fails to respond properly. The automated system executes accelerating, braking, and steering. The automated system can deactivate immediately upon takeover by the driver
Level 3 The automated system can control the vehicle in all but a few environments such as severe weather. The driver must enable the automated system only when it is safe to do so. When enabled, driver attention is not required.
Level 4 The automated system can control the vehicle in all but a few environments such as severe weather. The driver must enable the automated system only when it is safe to do so. When enabled, driver attention is not required
Level 5 Other than setting the destination and starting the system, no human intervention is required. The automatic system can drive to any location where it is legal to drive

Certain vehicles provide different levels of autonomous driving functionality depending on the road on which the vehicle is being driven. That is, the level of autonomous driving that the vehicle has available for use on any particular road (or road segment) depends on the level of autonomous driving available on that road.

While the above described maps display information about the nature of the roads in the road network, such as color coding the roads and graphically depicting them show whether they are local roads, state highways, federal highways, interstate highways, etc., they have not shown the roads in a way that shows the level of autonomous driving that is available on the roads displayed on the map. U.S. Pat. No. 9,008,961 for Determining and Displaying Auto Drive Lanes in an Autonomous Vehicles displays whether a driving lane is available for autonomous driving and how much further a vehicle can travel in the autonomous driving mode in that driving lane, and also indicating remaining autodrive distance in other lanes. U.S. Pat. No. 9,008,961 does not, however, for each of the roads in the road network display on the map indicators indicative of the level of autonomous driving available on each road.

### SUMMARY

In accordance with an aspect of the present disclosure, a map of a road network is displayed on a system of an automotive vehicle. The system generates the map of the road network including an autonomous driving level indicator for each road in the road network that has autonomous driving available that indicates a level of autonomous driving that such road has available for the vehicle and displays the map of the road network on the display.

In accordance with an aspect, if any road in the road network has different levels of autonomous driving available for the vehicle on different segments of the road, the system generates the map with an autonomous driving level indicator for each such segment of the road that indicates a level of autonomous driving that such segment has available.

In accordance with an aspect, the system receives data from a remote system that includes the levels of autonomous driving available on the roads of the road network and generates the map with the autonomous driving level indicators in accordance with such data received from the remote system.

In accordance with an aspect, system has stored in a memory of the system data that includes the levels of autonomous driving available on the roads of the road network and generates the map with the autonomous driving level indicators in accordance with such data stored in memory.

### BRIEF DESCRIPTION OF THE DRAWINGS

The present invention will become more fully understood from the detailed description and the accompanying drawings, wherein:

FIG. 1A is a simplified block diagram of an automotive vehicle in which a map of a road network with autonomous drive level indicators are displayed on a display of a system of the vehicle in accordance with an aspect of the present disclosure;

FIG. 1B is a perspective view of a display of the automotive vehicle of FIG. 1A;

FIG. 2 is a simplified display of a map of a road network in accordance with an aspect of the present disclosure;

FIG. 3 is a flow chart of an illustrative control routine for displaying the map of the road network with autonomous driving level indicators in accordance with an aspect of the present disclosure; and

FIG. 4 is a variation of the flow chart of FIG. 3.

### DETAILED DESCRIPTION

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

In accordance with an aspect of the present disclosure, a map display routine implemented in an electronic control unit of an automotive vehicle displays on a display of the vehicle a map of a road network with indicators that indicate the level of autonomous driving that each road in the road network has available to a vehicle configured to utilize that level of autonomous driving. In an aspect, the indicators are colors with the roads color coded to indicate the level of autonomous driving that each road has available or the roads highlighted with colors to indicate the level of autonomous driving that each road has available.

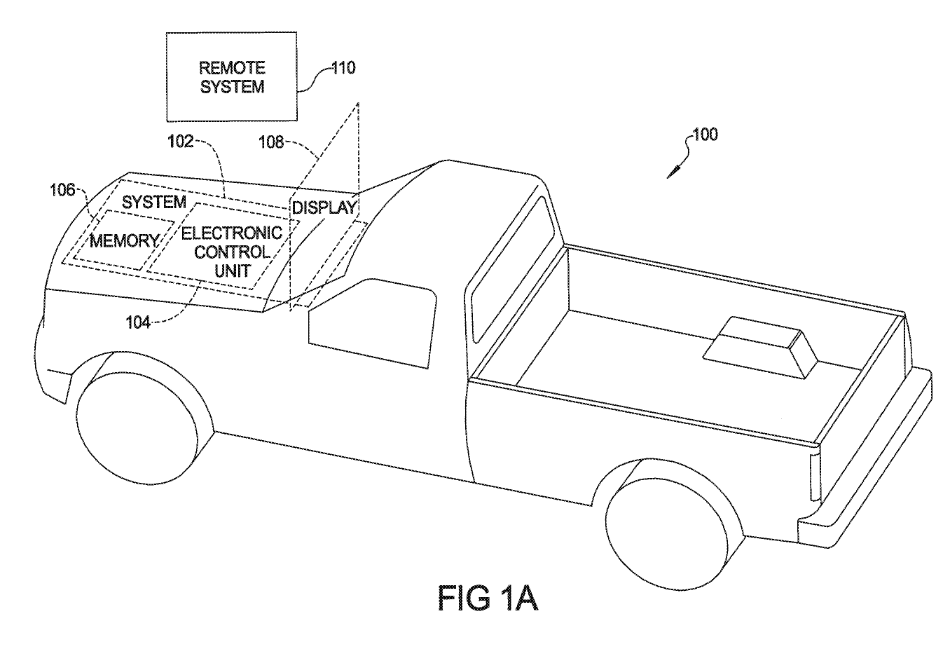

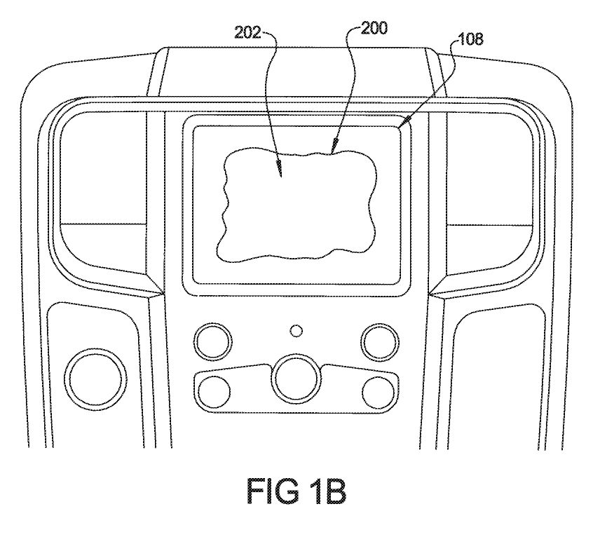

FIG. 1A is a simplified diagram of an automotive vehicle 100 having a system 102, such as a navigation system, that displays a map 200 (FIG. 1B and as best shown in FIG. 2) of a road network 202 on a display 108 (FIG. 1B) of the vehicle 100. System 102 includes an electronic control unit 104 having a memory 106. Display 108 is coupled to electronic control unit 104.

With reference to FIG. 2, road network 202 includes roads 204 that are displayed on display 108 as when road network 202 is displayed. Any road 204 may be divided into road segments 204′ as discussed in more detail below. For clarity in FIG. 2, only some of roads 204 and road segments 204′ are identified by reference numbers 204, 204′.

In an aspect, each road 204 is displayed with an indicator that indicates the level of autonomous driving available on that road 204. These levels are referred to herein Autonomous Driving Levels and collectively as Autonomous Driving Levels and the indicators are referred to herein as Autonomous Driving Level Indicators 205. For clarity in FIG. 2, only some of roads 204 and road segments 204′ are identified by reference numbers 204, 204′ and only some of Autonomous Driving Level Indicators 205 are identified by reference number 205.

In an aspect, the Autonomous Driving Indicator is a color indicative of the level of autonomous driving available on that road. By way example only and not of limitation, the letters G, B, Y, O and R in FIG. 2 indicate the colors for the Autonomous Driving Levels of autonomous as follows: G—green—level 5; B—blue—level 4; For example, shown by the letters G (green—level 5), B (blue—level 4), Y (yellow—level 3), O (orange—level 2) and R (red—level 1) in FIG. 2. In an aspect, the line for the road 204 on the map 204 has the color of the applicable Autonomous Driving Level. In an aspect, the road 204 is highlighted with the color of the applicable Autonomous Driving Level which allows the color of the road 204 to then be a color of the type of road that it is (e.g., Interstate Highway, Federal Highway, State Highway, etc.) such as the colors typically used by navigation systems in the display of roads in maps of road networks. In the foregoing example, roads that have a 0 Autonomous Driving Level are displayed without an Autonomous Driving Level Indicator since these roads do not provide any autonomous driving capability. In an alternative, roads having a 0 Autonomous Driving Level are also displayed with an Autonomous Driving Level Indicator 205, such as a color.

An individual road 204 may not have the same Autonomous Driving Level available along the entire road. In this case, each segment 204′ of that road 204 is displayed with the applicable Autonomous Driving Level Indicator for the Autonomous Driving Level available on that road segment 204′, as shown in FIG. 2. In this regard, unless the context dictates otherwise, references to roads 204 having Autonomous Driving Levels and Autonomous Driving Level Indicators also include road segments 204′ of the roads 204.

In an aspect, a map database of roads in a geographic region such as the United States and Canada is stored in memory 106 of system 102. In an aspect, the map database includes the Autonomous Driving Levels for the roads in the map database. In an aspect, system 102 receives data of the Autonomous Driving Levels for the roads in the map database from a remote system (110), stores this data in memory 106 and utilizes this data to determine the Autonomous Driving Level Indicators to display for the roads 204 on map 200. In this regard, the roads 204 displayed on map 200 are a subset of the roads in the map database and are illustratively the roads 204 of the road network in a localized geographic region in which vehicle 100 is presently located, such as the roads in a road network conventionally displayed by a vehicle navigation system. In an aspect, system 102 receives in real-time data from the remote system 110 of any changes in the Autonomous Driving Levels for the roads in the map database due to changed road conditions, such as weather, construction or the like, and changes the Autonomous Driving Level Indicators for the roads 204 accordingly. In an aspect, system 102 receives in real-time data from the remote system of any changes in the Autonomous Driving Levels for the roads 204 that are currently being displayed on the map 200 of the road network 202 and changes the Autonomous Driving Level Indicators for the roads 204 accordingly. In an aspect, system 102 queries the remote system 110 for any changes to the Autonomous Driving Levels of the roads 204 that are currently being displayed on the map 200 of the road network 202, receives data of any such changes from the remote system 110, and changes the Autonomous Driving Level Indicators for the roads 204 accordingly.

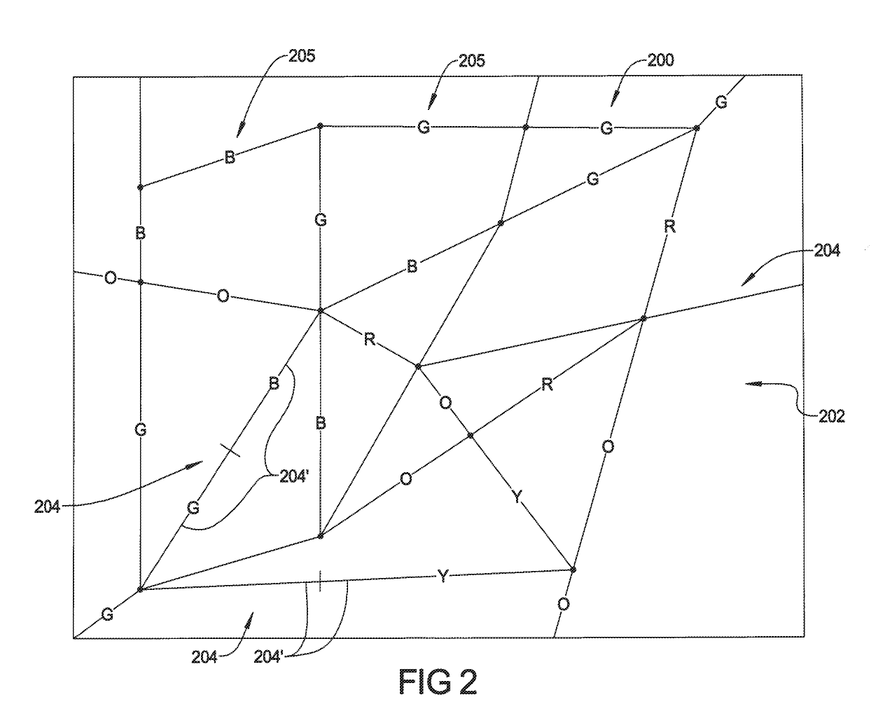

FIG. 3 is a flow chart of an illustrative control routine implemented in control logic in electronic control unit 104 to display map 200 of road network 202 with Autonomous Driving Level Indicators 205 for roads 204. The routine starts at 300 and proceeds to 302. At 302, the routine retrieves from memory 106 of system 102 data for the roads in a localized geographic region in which the vehicle 100 is located and then proceeds to 304 where it generates the map 200 of road network 204 including the Autonomous Driving Level Indicators 205 utilizing this data. The routine then proceeds to 306 where the routine displays on display 108 the map 200. The routine then proceeds to 308 where it ends. Alternatively, as shown in phantom in FIG. 3, the routine loops back to 302 and map 200 is then updated to reflect the change in the geographic region in which the vehicles is located as the vehicle moves in the geographic region.

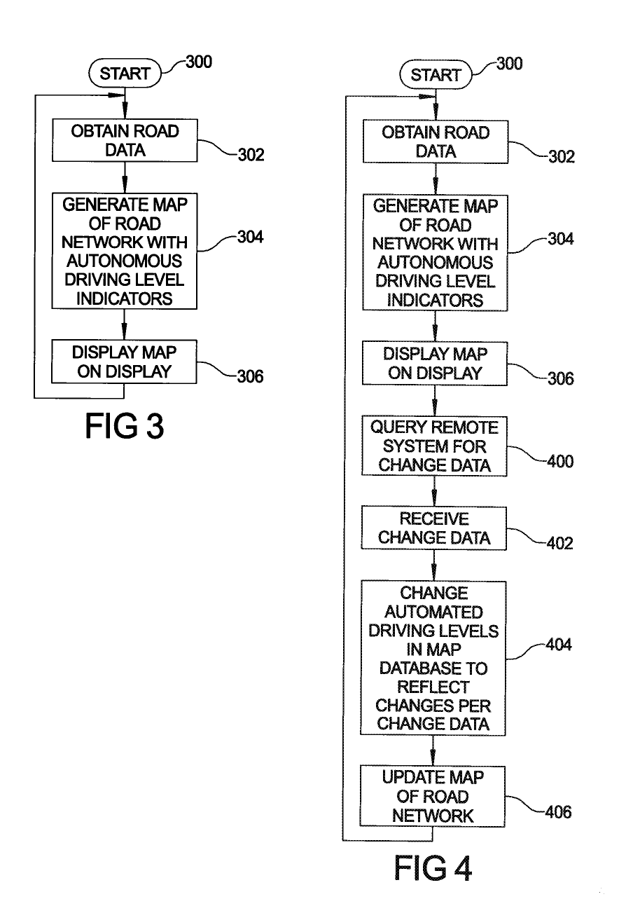

FIG. 4 is a flow chart of a variation of the control routine of FIG. 3, and only the differences will be discussed. After 306, the control routine proceeds to 400 where it queries remote system 110 for data regarding any changes to the Autonomous Driving Levels, for all the roads in the map database or, alternatively, for the roads 204 presently being displayed on map 200. The routine then proceeds to 402 where it receives data of any such changes. It then proceeds to 404 where it changes the Autonomous Driving Levels in the map database according to the received data and then proceeds to 406 where it updates the map 200 accordingly. It then proceeds to 308 or, alternatively, back to 302 as shown in phantom. It should be understood that in an aspect system 102 receives data from remote system 110 of any changes in the Autonomous Driving Levels periodically or in real time without querying remote system 110 in which case the routine does not have block 400.

The electronic control unit such as electronic control unit 104 in which any of the above cargo position tracking routines are implemented is or includes any of a digital processor (DSP), microprocessor, microcontroller, or other programmable device which are programmed with software implementing the above described methods. It should be understood that alternatively it is or includes other logic devices, such as a Field Programmable Gate Array (FPGA), a complex programmable logic device (CPLD), or application specific integrated circuit (ASIC). When it is stated that the electronic control unit 104 or any of the cargo tracking control routines implemented in electronic control unit 104 performs a function or is configured to perform a function, it should be understood that the electronic control unit 104 is configured to do so with appropriate logic (such as in software, logic devices, or a combination thereof).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of displaying a map of a road network on a display of a system of an automotive vehicle, comprising:
generating with the system of the automotive vehicle the map of the road network including an autonomous driving level indicator for each road in the road network that has autonomous driving available that indicates a level of autonomous driving that such road has available for the vehicle; and
displaying the map of the road network on the display.

2. The method of claim 1 wherein if any road in the road network has different levels of autonomous driving available for the vehicle on different segments of the road, generating the map includes generating the map with an autonomous driving level indicator for each such segment of the road that indicates a level of autonomous driving that such segment has available.

3. The method of claim 2 including receiving with the system of the automotive vehicle data from a remote system that includes the levels of autonomous driving available on the roads of the road network and generating the map with the autonomous driving level indicators in accordance with such data received from the remote system.

4. The method of claim 2 wherein the system has stored in a memory of the system of the automotive vehicle data that includes the levels of autonomous driving available on the roads of the road network, the method including generating the map with the autonomous driving level indicators in accordance with such data stored in memory.

5. An automotive vehicle, comprising:
a navigation system, the navigation system having a display and an electronic control unit coupled to the display; and
the electronic control unit configured to generate a map of a road network including an autonomous driving level indicator for each road in the road network that has autonomous driving available that indicates a level of autonomous driving that such road has available and displaying the map of the road network on the display.

6. The automotive vehicle of claim 5 wherein if any road in the road network has different levels of autonomous driving available for the vehicle on different segments of the road, the electronic control unit is configured to generate the map with an autonomous driving level indicator for each such segment of the road that indicates a level of autonomous driving that such segment has available.

7. The automotive vehicle of claim 6 including receiving with the navigation system data from a remote system that includes the levels of autonomous driving available on the roads of the road network and the electronic control unit configured to generate the map with the autonomous driving level indicators in accordance with such data received from the remote system.

8. The automotive vehicle of claim 6 wherein the navigation system has stored in a memory of the navigation system data that includes the levels of autonomous driving available on the roads of the road network, the electronic control unit configured to generate the map with the autonomous driving level indicators in accordance with such data stored in memory.
